(19) United States
(12) Patent Application Publication
(10) Pub. No.: US 2012/0171392 A1
(43) Pub. Date: Jul. 5, 2012

(54) Optical Films with Controlled Surface Morphology and the Method of Manufacturing the Same

(75) Inventors: Yong Gyun Cho, Daejeon (KR); Chol Ho Lee, Daejeon (KR); Yoo Seock Hwang, Daejeon (KR); Hyuk Jun Kim, Daejeon (KR); Ki Yup Kim, Seoul (KR); Sung Ho Son, Daejeon (KR); Ki-Beom Kim, Daejeon (KR); Kwang Jin Chung, Daejeon (KR); Jun Tae Choi, Daejeon (KR)

(73) Assignee: SK INNOVATION CO., LTD., Seoul (KR)

(21) Appl. No.: 13/394,756

(22) PCT Filed: Sep. 2, 2010
(86) PCT No.: PCT/KR10/05966

§ 371 Date: Mar. 7, 2012

(30) Foreign Application Priority Data
Sep. 8, 2009 (JP) 10-2009-0084348

(51) Int. Cl. C09K 19/02; B29D 11/00; G02B 1/04; B32B 3/30; G02B 1/08

(52) U.S. Cl. 428/1.31; 428/142; 428/141; 428/1.3; 264/1.1

(57) ABSTRACT

Provided are an optical film for use in flat panel display (FPD) devices, and a method for manufacturing the same. Particularly, there is provided a method for imparting surface roughness to an optical film, which includes forming dented craters having a radius of curvature of 10 nm-100 μm on the surface of an optical film obtained by a solution casting process and forming a plateau between one crater and another crater. There is also provided an optical film obtained by the same method.

### TECHNICAL FIELD

The present invention relates to a method for manufacturing an optical film having controlled surface roughness, which includes drying the surface of a film formed by a solution casting process with moisture-containing air to form surface morphology having craters and plateaus, and an optical film having controlled surface morphology and obtained from the same method.

### BACKGROUND ART

Flat panel display devices, such as liquid crystal display devices or organic light emitting diodes (OLEDs), use a polarizer. To fabricate a polarizer, a polyvinyl alcohol (PVA) film is used in combination with an optical protective film. In the case of an optical film for protecting and supporting a polarizer, used on the surface that the user views directly, anti-glare coating, low-reflection coating, anti-reflection coating, etc., are applied to provide an anti-glare effect. Hard-clear coating is also used to improve the surface hardness and light transmittance. Currently, coating productivity in surface coating of optical films is limited by hydrodynamic instability during a coating process. Typical phenomena related to such instability include bubble generation or ribbing occurring under an increased coating speed. Such bubble generation tends to be decreased significantly in proportion to the surface roughness (Aiche Journal, Vol. 33, page 141, 1987). In addition, coating instability caused by ribbing may be inhibited by increasing the roughness of a substrate surface to cause capillary flow in the surface. Therefore, use of a high-surface roughness substrate is capable of inhibiting bubble generation and ribbing, resulting in an increase in coating speed and improvement of productivity. Further, increased surface roughness improves the adhesion between a coating layer and a substrate layer, thereby improving mechanical and physical properties of the finished film.

In a process for fabricating a polarizer, an adhesive is used for the lamination of a polyvinyl alcohol film with a polarizer protection film or optical compensation film. During such a lamination process, the polarizer may be wrinkled by ribbing. Moreover, when the lamination process is carried out under a high speed, bubbles may be incorporated between the adhesive and the polyvinyl alcohol film or between the adhesive and the polarizer protection film or optical compensation film, resulting in a drop in polarizer productivity. Likewise, use of a high-surface roughness substrate may increase the lamination speed.

In general, air incorporation occurs well as the viscosity of a coating solution increases and the interfacial tension of a coating solution decreases, thereby restricting the maximum coating speed (Aiche Journal, Vol. 33, page 141, 1987). However, even when a coating solution having high viscosity and low interfacial tension is used, coating productivity may be increased significantly by using a film having controlled roughness derived from controlled surface morphology.

The inventors of the present invention have conducted many studies to develop a method for ensuring a uniform surface roughness over the whole surface of an optical film so that the coating productivity of a surface-coated optical film and the productivity in a polarizer lamination process may be improved. As a result, we have found that when drying air having a controlled moisture content is used for a drying operation in a process for forming an optical film, it is possible to control the morphology on the film surface and to obtain a film having controlled surface roughness. The present invention is based on this finding.

### DISCLOSURE OF INVENTION

### Technical Problem

An object of the present invention is to improve the productivity of a surface-coated film by controlling the surface roughness of an optical film to increase the coating speed during the surface coating of the optical film, as well as to improve the productivity during a polarizer manufacturing process. Therefore, an object of the present invention is to provide an optical film having controlled surface roughness and a method for manufacturing the same.

### Solution to Problem

In one general aspect, there are provided an optical film for use in flat panel display (FPD) devices, and a method for manufacturing the same. Particularly, there is provided a method for imparting surface roughness to an optical film, which includes: forming dented craters having a radius of curvature of 10 nm-100 μm on the surface of an optical film obtained by a solution casting process and forming a plateau between one crater and another crater. There is also provided an optical film obtained by the same method.

More particularly, there is provided an optical film obtained by subjecting a polymer solution to a solution casting process, followed by drying, the optical film having controlled surface roughness by forming craters and plateaus on the film surface by using drying air containing a gas non-affinitive to the solvent used in the polymer solution when drying the polymer solution after the solution casting.

The gas non-affinitive to the solvent used in the polymer solution may be water steam.

There is no particular limitation in the optical film. However, particular examples of the optical film may include cellulose acylate-based films, acrylic films, polynorbornene-based films, polycarbonate-based films, polysulfone-based films, polyether sulfone-based films, polystyrene-based films, polyetheretherketone-based films, polyvinyl alcohol-based films, polyvinyl acetate-based films, or the like.

In another general aspect, there is provided a method for manufacturing an optical film via a solution casting process, which includes subjecting a polymer solution to solution casting and drying the polymer solution by supplying drying air containing a gas non-affinitive to the solvent used in the polymer solution into a caster so as to form craters on the surface of a cast layer that is in contact with the drying air, while forming a plateau between one crater and another crater, thereby controlling the surface roughness of a finished film.

Hereinafter, the embodiments of the present invention will be described in detail.

In general, optical films for flat panel displays are obtained by a solution casting process or a melt extrusion process. In the case of a solution casting process, cellulose acylate resins, polynorbornene resins, etc. may be used. In the case of a melt extrusion process, acrylic resins, polyethylene terephthalate (PET) resins, aliphatic cycloolefin (COP) resins, etc. may be used.

Hereinafter, a method for manufacturing a cellulose acylate film will be described; however, optical films that may be obtained from the method of the present invention are not limited thereto.

In the case of solution casting, a polymer solution is cast onto a steel belt or drum in a caster, dried partially, dried completely while being passed through a tenter or drier, and then wound on a winder in the form of a film. During a solution casting process, relative humidity of drying air may be controlled in the caster to make droplet marks on the surface of a cast solution layer, and such droplets have a very narrow size distribution. Because the size and distribution of the droplet marks may be controlled by controlling relative humidity of drying air and drying speed, it is possible to control the surface roughness of an optical film. The surface of the cast solution layer in the caster that is in direct contact with the drying air has a skin layer formed rapidly by convection drying. It is possible to control the roughness of an optical film by controlling the surface morphology before the skin layer is solidified. The amount of residual solvent in the cast layer is 10-70% when the cast layer is discharged from the caster. However, because the surface that has been already in contact with the drying air is substantially solidified, the droplet marks are retained after being passed through the tenter and drier, and thus maintained in a finished film.

Coating solutions, such as hard clear coating, antiglare coating or low reflection coating solutions, used widely in optical films fill a rough surface of a substrate during a coating process even under a roughness of several micrometers or less. Thus, the portion that is in contact with drying air is leveled to provide a flat coating surface. Therefore, coating solutions having a refractive index controlled depending on a substrate may remove the surface haze of a substrate sufficiently even when the substrate has high roughness. In this manner, a finished coating film shows no haze caused by the roughness of a substrate surface. In conclusion, the film obtained by controlling the surface roughness of a film in accordance with an embodiment of the present invention is capable of increasing coating productivity while not adversely affecting desired optical properties of a finished surface coated film.

Such a film having controlled surface roughness in accordance with an embodiment of the present invention may be used directly as an anti-glare film or light diffusion film by controlling the film haze through the droplet marks.

As methods for producing optical compensation films for use in IPS or VA modes, various methods, such as direct addition of a low-molecular weight material capable of controlling optical anisotropy to a resin optionally in combination with elongation of a film, are known in the art. Likewise, when optical compensation films are obtained through the above methods, it is possible to control the surface roughness with ease by forming craters on the surface of a compensation film in accordance with an embodiment of the present invention, with the proviso that the film is subjected to solution casting. In addition, various methods of producing optical compensation films for TN modes are disclosed in many patents, the methods including coating a liquid crystal layer on a cellulose acylate film and imparting orientability to the liquid crystal layer. The film having controlled roughness in accordance with an embodiment of the present invention may also be applied to the cellulose acylate film used as a substrate in the above-mentioned methods.

As used herein, the polymer solution may include a cellulose acylate resin, a solvent and additives.

The cellulose acylate that may be used in the method disclosed herein may have any C2-C20 acyl substituent. The cellulose acylate may have a substitution degree of 2.50-3.00, more specifically 2.75-3.00. In addition, cellulose acylate having two or more acylate groups with a different number of carbon atoms may be used. In this case, acetyl may be an acyl group with a lower number of carbon atoms, while another acyl group with a higher number of carbon atoms may include an aliphatic acyl group, such as propionyl or butyryl, or an aromatic structure, such as benzoyl.

The cellulose acylate may have a weight average molecular weight of 200,000-350,000 in view of mechanical properties, dimensional stability and optical durability. The cellulose acylate may have a polydispersity (weight average molecular weight/number average molecular weight) of 1.4-1.8.

Also, two or more kinds of cellulose acylate resins may be used.

The solvent may include at least one selected from methylene chloride, methyl acetate, ketones and alcohols. Preferably, organic solvents may include halogenated hydrocarbons, methylene chloride being advisable for commercial processes. If desired, organic solvents other than such halogenated hydrocarbons may be used in combination. Such organic solvents other than halogenated hydrocarbons may include esters, ketones, ethers, alcohols, etc. In general, methylene chloride is used as a main solvent and alcohol is used as a co-solvent. More particularly, a mixture of methlylene chloride and alcohol is used in a weight ratio of 80:20-95:5.

When making the cellulose acylate film, various additives may be added while the polymer solution is prepared. Typical examples of such additives include plasticizers, mattifying agents, microparticle powder, surfactants, UV absorbing agents, stripping agents, wavelength dispersion adjusting agents, optical anisotropy controlling agents, etc. Such additives may be used without any particular limitation as long as they are known to those skilled in the art.

As a plasticizer, phosphoric acid ester, carboxylic acid ester, such as one selected from phthalic acid ester and citric acid ester, etc., may be used. Particular examples of phosphoric acid ester include triphenyl phosphate (TPP), biphenyl diphenyl phosphate and tricresyl phosphate (TCP). Particular examples of phthalic acid ester include dimethyl phthalate (DMP), diethyl phthalate (DEP), dibutyl phthalate (DBP), dioctyl phthalate (DOP), diphenyl phthalate (DPP) and diethylhexyl phthalate (DEHP). Particular examples of citric acid ester include o-acetyl triethyl citrate (OACTE) and o-acetyl tributyl citrate (OACTB). Examples of other carboxylic acid ester include butyl oleate, methyl acetyl lysine oleate, dibutyl sebacate and various trimelitic acid esters. Two or more plasticizers may be used in combination. The plasticizer may be used in an amount of 0.05-30 parts by weight based on 100 parts by weight of cellulose acylate.

As a wavelength dispersion adjusting agent, a benzotriazole compound, benzophenone compound, oxybenzophenone compound, salicylic acid ester compound, cyano group-containing compound, or the like may be used alone or in combination. The wavelength dispersion adjusting agent may be used in an amount of 0.05-30 parts by weight based on 100 parts by weight of cellulose acylate.

As a UV absorbing agent, an oxybenzophenone compound, benzotriazole compound, salicylic acid ester compound, benzophenone compound, cyanoacrylate compound, nickel complex salt compound, or the like may be used. Among those, a benzotriazole compound is preferred. Particular examples of a benzotriazole-based UV absorbing agent include, but are not limited to: 2-(2′-hydroxy-5′-methylphenyl)benzotriazole, 2-(2′-hydroxy-3′,5′-di-tert-butylphenyl)benzotriazole,
2-(2′-hydroxy-3′-tert-butyl-5′-methylphenyl)benzotriazole,
2-(2′-hydroxy-3′,5′-di-tert-butyl)-5-chlorobenzotriazole,
2-(2′-hydroxy-3′-(3″,4″,5″,6″-tetrahydro phthalimidomethyl)-5′ methylphenyl)benzotriazole, 2,2-methylenebis(4-(1,1,3,3-tetramethyl butyl)-6-(2H-benzotriazole-2-yl)phenol),
2-(2′-hydroxy-3′-tert-butyl-5′-methylphenyl)-5-chlorobenzotriazole,
2,4-dihydroxybenzophenone, 2,2′-dihydroxy-4-methoxybenzophenone,
2-hydroxy-4-methoxy-5-sulfurbenzophenone,
bis(2-methoxyl-4-hydroxy-5-benzoylphenyl methane), 2,6-di-tert-butyl-p-cresol, triethyleneglycol-bis(3-(3-tert-butyl-5-methyl-4-hydroxy phenyl)propionate),
1,6-hexanediol-bis(3-(3,5-di-tert-butyl-4-hydroxyphenyl)propionate,
2,4-bis-(n-octylthio)-6-(4-hydroxy-3,5-di-tert-butylanilino)-1,3,5-triazine,
2,2-thiodiethylenebis(3-(3,5-di-tert-butyl-4-hydroxyphenyl)propionate), octadecyl-3-(3,5-di-tert-butyl-4-hydroxy phenyl)propionate,
1,3,5-trimethyl-2,4,6-tris(3,5-di-tert-butyl-4-hydroxybenzyl)benzene, tris-(3,5-di-tert-butyl-4-hydroxybenzyl)-isocyanurate, or the like. In addition, metal oxides, such as silicon dioxide, titanium dioxide, zinc oxide, aluminum oxide, barium oxide, tin oxide, magnesium oxide, molybdenum oxide, vanadium oxide, etc. may be added in combination with the above-mentioned UV absorbing agent in order to improve a UV absorbing effect.

Microparticle powder is added to facilitate inhibition of film curling, send-back characteristics during use, prevention of lamination in a roll-wound state, or the like. Any microparticle powder selected from inorganic compounds and organic compounds may be used. Particular examples of such inorganic compounds include silicon-containing compounds, silicon dioxide, titanium dioxide, zinc oxide, aluminum oxide, barium oxide, zirconium oxide, strontium oxide, antimony oxide, tin oxide, tin/antimony oxide, calcium carbonate, talc, clay, baked kaolin, baked calcium silicate, hydrated calcium silicate, aluminum silicate, magnesium silicate and calcium phosphate. Silicon-containing inorganic compounds or zirconium oxide is preferred. The microparticle has an average primary particle diameter of 80 nm or less, preferably 5-80 nm, more preferably 5-60 nm, most preferably 8-50 nm. The microparticle powder may be used in an amount of 0.001-5 parts by weight based on 100 parts by weight of cellulose acylate.

As a stripping agent, phosphate, sulfonate, carboxylate, nonionic, cationic surfactants, or the like may be used. The stripping agent may be used in an amount of 0.005-2 wt % based on the weight of the polymer solution.

As a surfactant, nonionic, anionic, cationic, betaine, fluoro surfactants, or the like may be used. Preferred nonionic surfactants include polyoxyethylene, polyoxypropylene, polyoxybutylene, polyoxyethylenealkyl ether, polyoxyethylenealkylphenyl ether, polyoxyethylene-polyoxypropylene glycol, polyhydric alcohol fatty acid partial ester, polyoxyethylene polyhydric alcohol fatty acid ester, polyoxyethylene fatty acid ester, polyglycerin fatty acid ester, fatty acid diethanol amide, triethanolamine fatty acid partial ester, or the like. Particular examples of the anionic surfactant include carboxylate salts, sulfate salts, phosphoric acid ester salts, etc., and typical examples thereof include fatty acid salts, alkylbenzene sulfonate salts, alkyl naphthalene sulfonate salts, alkyl sulfonate salts, α-olefin sulfonate salts, α-sulfonated fatty acid salts, alkyl sulfate salts, polyoxyethylene alkyl ether sulfate salts, polyoxyethylene alkyl phenyl ether sulfate salts, polyoxyethylene styrene phenylene ether sulfate salts, alkyl phosphate salts, polyoxyethylene alkyl ether phosphate salts, or the like. Particular examples of the cationic surfactant include primary-tertiary fatty amine salts, tetraalkyl ammonium salts, trialkylbenzyl ammonium salts, or the like. Particular examples of the betaine surfactant include carboxybetaine, sulfobetaine, N-trialkyl-N-carboxymethylammoniumbetaine, N-trialkyl-N-sulfoalkyleneammoniumbetaine, or the like. The surfactant may be used in an amount of 0.001-2 parts by weight based on 100 parts by weight of cellulose acylate.

The optical anisotropy controlling agent may be low-molecular weight compounds or polymeric compounds, and used in an amount of 0.001-30 parts by weight based on 100 parts by weight of cellulose acylate.

The optical film according to the present invention has a thickness of 20-150 μm to facilitate fabrication of a polarizer. The optical film has a surface roughness (Ra) of 5 nm-20 μm to improve productivity in coating and fabrication of a polarizer. The surface roughness means an average surface roughness on the basis of the central line. In the case of a transparent optical film, a confocal microscope may be used to obtain the sectional view of a surface, and then Ra may be calculated according to the definition of Ra.

The optical film according to the present invention has a haze controllable easily from 1 to 100%. The optical film may further include at least one coating layer selected from a hard clear coating layer, anti-glare coating layer, low reflection coating layer, anti-reflection coating layer, antistatic coating layer and liquid crystal coating layer, on either surface or both surfaces thereof. The optical film allows easy formation of such a coating layer due to its surface roughness.

The optical film according to the present invention may be applied to IPS modes or VA modes depending on its optical characteristics. The optical film may also be applied to a substrate film of an optical compensation film for TN-mode liquid crystal display devices. Such films may be used for producing polarizers.

Further, liquid crystal display devices or OLEDs using the polarizer including the optical film according to the present invention are also within the scope of the present invention.

### Advantageous Effects of Invention

The optical film according to the present invention has controlled surface morphology, so that bubbles generated during a coating process may be removed easily and a capillary phenomenon may occur in the film. In this manner, it is possible to increase coating speed by inhibiting bubble generation and ribbing even under an increased coating speed. As a result, it is possible to improve the productivity in a coating process and the productivity in a lamination process of a method for manufacturing a polarizer.

### BRIEF DESCRIPTION OF DRAWINGS

The above and other objects, features and advantages of the present invention will become apparent from the following description of preferred embodiments given in conjunction with the accompanying drawings, in which:

FIG. 1 is a photographic view of an optical film having controlled surface morphology, obtained with a retention time of 240 seconds in a caster according to the present invention;

FIG. 2 is a photographic view of an optical film having controlled surface morphology, obtained with a retention time of 100 seconds in a caster according to the present invention; and

FIG. 3 is a photographic view showing the section of the optical film as shown in FIG. 1, wherein the dented portion and the non-dented portion are referred to as a crater and a plateau, respectively.

### MODE FOR THE INVENTION

The examples and experiments will now be described. The following examples and experiments are for illustrative purposes only and not intended to limit the scope of the present invention.

Physical properties of a film are measured according to the following methods.

1) Transmittance (%)

Transmittance of a sample with a size of 20 mm×70 mm is measured through a transparency measuring system (AKA photoelectric colorimeter, Kotaki Seisakusho) under visible light (615 nm) at 25° C., 60% RH.

2) Haze (%)

Haze of a film sample with a size of 40 mm×80 mm is measured by a hazemeter (HGM-2DP, Suga Test Instruments) at 25° C., 60% RH according to JISK-6714.

### EXAMPLE 1

### Preparation of Cellulose Acylate Solution

The composition as described hereinafter is introduced into an agitator and dissolved therein at a temperature of 30° C.:

Cellulose acetate 19 wt %

Methylene chloride 73 wt %

Methanol 6.0 wt %

Triphenyl phosphate 1.05 wt %

Biphenyl diphenyl phosphate 0.5 wt %

UV absorbing agent 1 (Tinuvin 328, Ciba) 0.2 wt %

UV absorbing agent 2 (Tinuvin 327, Ciba) 0.2 wt %

SiO₂ 0.05 wt %

Cellulose acetate having a weight average molecular weight of 250,000 and a substitution degree of 2.8 is used. SiO₂ used herein has an average primary particle diameter of about 20 nm. The resultant solution is sent by a gear pump warmed to 30° C., filtered through a filter paper with an absolute filtration accuracy of 0.01 mm, and then further filtered through a cartridge filter with an absolute filtration accuracy of 5 μm.

Manufacture of Cellulose Acylate Film

The solution obtained from the preceding filtering operation is cast onto a mirror surface stainless steel support disposed inside a caster through a casting die, followed by stripping. When drying the solution in the caster, air with a relative humidity of 70% is supplied after mixing it with drying air at 100° C. under ambient pressure. The residual solvent amount is controlled to 25 wt % upon the stripping. After connecting the film to a tenter, the film is elongated in the transverse direction at a ratio of 101%. After the film is discharged from the tenter, the film is cut at its left and right ends, each by a length of 150 mm. The end-cut film is dried through a drier, and then both ends of the film discharged from the drier are cut by 3 cm. Further, the film is subjected to a knurling process with a height of 10 μm at the position of 2 mm from the end position. Then, the film is wound into a roll to obtain a cellulose acetate film having controlled surface morphology. The film has the physical properties as listed in Table 1.

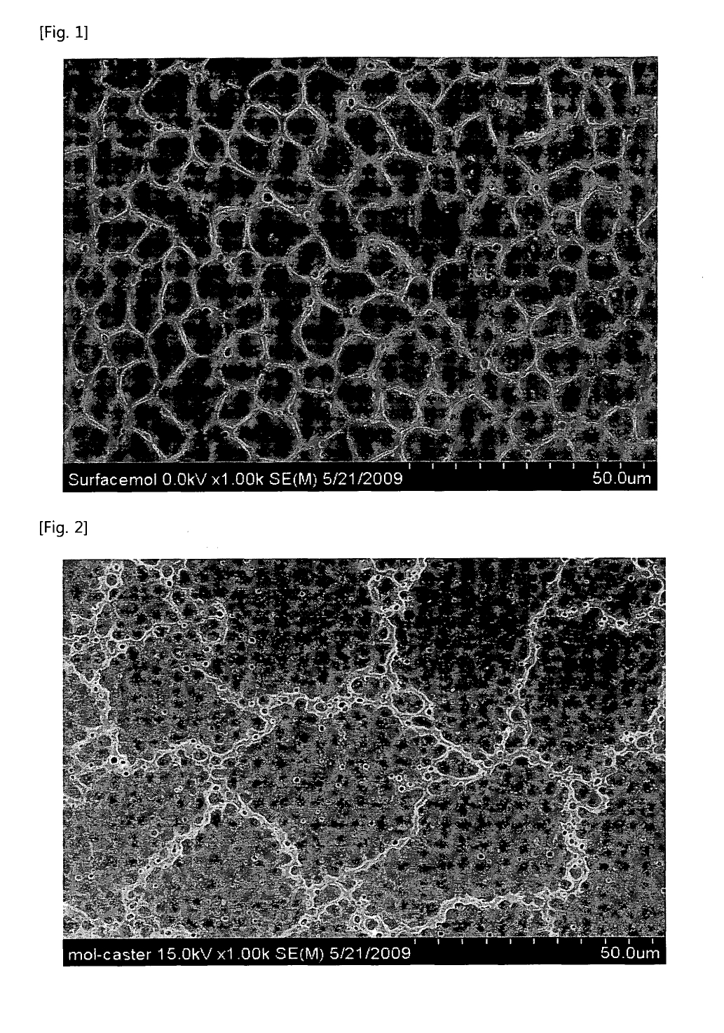

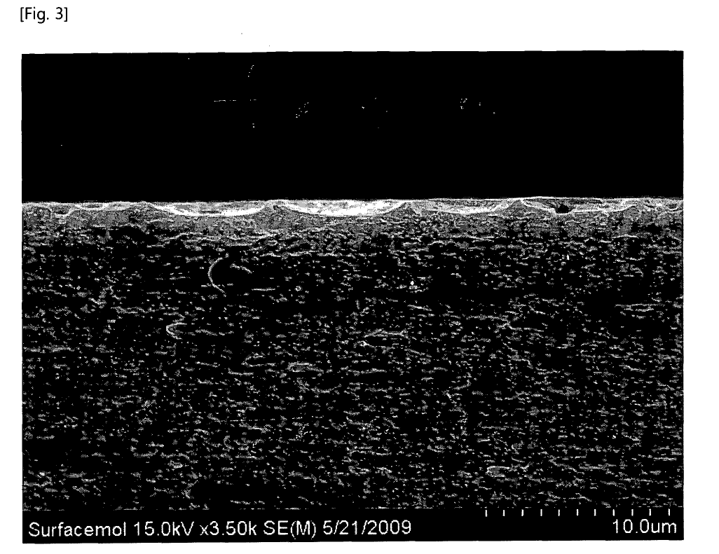

After the completion of this experiment, a haze film having the surface morphology as shown in FIGS. 1 and 2 is obtained. The physical properties of the film as shown in FIG. 2 are also listed in Table 1. The retention time in the caster is 240 seconds (FIG. 1) and 100 seconds (FIG. 2). FIG. 3 is a sectional view of the sample as shown in FIG. 1 taken along the thickness direction. In FIG. 3, the dented portion is referred to as a crater and the remaining non-dented portion is referred to as a plateau. As can be seen from FIG. 3, the craters are formed only on the surface of the film.

### EXAMPLE 2

The film obtained from Example 1 is used to provide a film with hard clear coating. A photocurable acrylic coating solution is coated onto the film of Example 1. The coating solution has a binder solid content of 43 wt % and includes 42.2 wt % of methyl ethyl ketone and 14.8 wt % of isopropyl alcohol as solvents. The coating solution is coated by using a No. 5 Mayer bar, dried in an oven at 100° C. for 30 seconds, and cured by UV light with an intensity of 57 mJ/cm²·s at 25° C. for 10 seconds. The dried and cured film shows a transparent appearance and has a coating layer thickness of about 5 μm and a pencil hardness of 3H. The film has the physical properties as listed in Table 1

### EXAMPLE 3

The same coating solution as the Mayer bar coating experiment of Example 2 is used and a cellulose acetate film having controlled surface morphology is used in a multicoater to determine a coating speed where bubble incorporation occurs. A slot die is used as a coating die and drying temperatures are controlled independently in three regions to 60° C., 100° C. and 110° C. To ensure the coating bead stability, vacuum suction is applied. The film has the physical properties as listed in Table 2.

### COMPARATIVE EXAMPLE 1

The same composition as Example 1 is used to provide a film in the same manner, except that the composition is cast onto a mirror surface stainless steel support disposed in a caster through a casting die, and the drying air used during the stripping does not include air with a relative humidity of 70% but include drying air only. As a result, a transparent cellulose acetate film is obtained and the film has the physical properties as listed in Table 1.

### COMPARATIVE EXAMPLE 2

The cellulose acetate film obtained from Comparative Example 1 is used and the coating solution is coated thereon in the same manner as described in Example 3. The coated film has the physical properties as listed in Table 2.

TABLE 1

| | Thickness (μm) | Transmittance (%) | Haze (%) |
|---|---|---|---|
| Ex. 1 | 80 | 91.6 | 28.4 |
| Ex. 2 | 85 | 93.0 | 0.35 |
| Comp. Ex. 1 | 80 | 93.5 | 0.27 |

As shown in Table 1, Example 1 has a high haze due to the formation of craters on the surface. However, as can be seen from Example 2, formation of a hard clear coating layer results in a decrease in haze.

TABLE 2

| | | Bubble | | |
|---|---|---|---|---|
| | Film thickness | incorporation | Transmittance | |
| | (μm) | rate (m/min) | (%) | Haze (%) |
| Ex. 3 | 85 | 49 | 93.6 | 0.23 |
| Comp. Ex. 2 | 85 | 36 | 93.5 | 0.24 |

As shown in Table 2, the cellulose acetate film having controlled surface morphology provides an increased bubble incorporation rate (Example 3), which is 1.36 times the bubble incorporation rate (Comparative Example 2) using the cellulose acetate film of Comparative Example 1. This demonstrates that high-surface roughness films having controlled surface morphology are capable of improving the productivity significantly in a film coating process.

The present application contains subject matter related to Korean Patent Application No. 10-2009-0084348, filed in the Korean Intellectual Property Office on Sep. 8, 2009 the entire contents of which is incorporated herein by reference.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

### INDUSTRIAL APPLICABILITY

The optical film according to the present invention may be applied to IPS modes or VA modes depending on its optical characteristics. The optical film may also be applied to a substrate film of an optical compensation film for TN-mode liquid crystal display devices. Such films may be used for producing polarizers.

Further, liquid crystal display devices or OLEDs using the polarizer including the optical film according to the present invention are also within the scope of the present invention.

1. A method for manufacturing an optical film, comprising subjecting a polymer solution to solution casting and drying the polymer solution by supplying drying air containing a gas non-affinitive to the solvent used in the polymer solution into a caster so as to form craters on the surface of a cast layer that is in contact with the drying air, while forming a plateau between one crater and another crater, thereby controlling the surface roughness of a finished film.

2. The method for manufacturing an optical film according to claim 1, wherein the gas non-affinitive to the solvent used in the polymer solution is water steam.

3. The method for manufacturing an optical film according to claim 2, wherein the optical film has a surface roughness (Ra) of 5 nm-20 μm.

4. The method for manufacturing an optical film according to claim 1, wherein the optical film is any one selected from cellulose acylate-based films, acrylic films, polynorbornene-based films, polycarbonate-based films, polysulfone-based films, polyether sulfone-based films, polystyrene-based films, polyetheretherketone-based films, polyvinyl alcohol-based films and polyvinyl acetate-based films.

5. The method for manufacturing an optical film according to claim 1, wherein the polymer solution comprises a cellulose acylate resin, a solvent and additives, and the solvent is at least one selected from methylene chloride, methyl acetate, ketones, alcohols and mixtures thereof.

6. The method for manufacturing an optical film according to claim 5, wherein the additives are at least one selected from plasticizers, mattifying agents, microparticle powder, surfactants, UV absorbing agents, stripping agents, wavelength dispersion adjusting agents, optical anisotropy controlling agents and mixtures thereof.

7. an optical film according to claim 1, which further comprises coating a hard clear coating layer, anti-glare coating layer, low reflection coating layer, anti-reflection coating layer, antistatic coating layer or liquid crystal coating layer onto either surface or both surfaces of the optical film, after said drying.

8. An optical film obtained by the method as defined in claim 1.

9. The optical film according to claim 8, which is a light diffusion film or an optical compensation film.

10. The optical film according to claim 8, which is an optical compensation film for IPS-mode, VA-mode or TN-mode liquid crystal display devices.

11. A polarizer using the optical film obtained by the method as defined in claim 1.

12. A liquid crystal display device or OLED display device using the polarizer as defined in claim 11.

13. An optical film having controlled surface roughness by forming craters and plateaus on the surface thereof with drying air comprising a gas non-affinitive to the solvent used in a polymer solution during solution casting.

14. The optical film according to claim 13, wherein the gas non-affinitive to the solvent used in a polymer solution is water steam.

15. The optical film according to claim 14, which is any one selected from cellulose acylate-based films, acrylic films, polynorbornene-based films, polycarbonate-based films, polysulfone-based films, polyether sulfone-based films, polystyrene-based films, polyetheretherketone-based films, polyvinyl alcohol-based films and polyvinyl acetate-based films.

16. The optical film according to claim 15, wherein the polymer solution comprises a cellulose acylate resin, a solvent and additives, and the solvent is at least one selected from methylene chloride, methyl acetate, ketones, alcohols and mixtures thereof.

17. The optical film according to claim 16, wherein the additives are at least one selected from plasticizers, mattifying agents, microparticle powder, surfactants, UV absorbing agents, stripping agents, wavelength dispersion adjusting agents, optical anisotropy controlling agents and mixtures thereof.

18. The optical film according to claim 13, which has a surface roughness (Ra) of 5-20 μm.

19. The optical film according to claim 18, which further comprises, on either surface or both surfaces thereof, at least one coating layer selected from a hard clear coating layer, anti-glare coating layer, low reflection coating layer, anti-reflection coating layer, antistatic coating layer or liquid crystal coating layer.

20. The optical film according to claim 19, which has a thickness of 20-150 μm.
